(19) United States
(12) Patent Application Publication
(10) Pub. No.: US 2012/0082590 A1
(43) Pub. Date: Apr. 5, 2012

(54) GAS HYDRATE REACTOR COMPRISING THERMOELECTRIC MODULE

(75) Inventors: Ju Dong LEE, Busan (KR); Young Cheol LEE, Busan (KR); Hyung Ho JO, Busan (KR); Hu-Kab CHO, Busan (KR)

(73) Assignee: KOREA INSTITUTE OF INDUSTRIAL TECHNOLOGY, Cheonan-si (KR)

(21) Appl. No.: 12/916,278

(22) Filed: Oct. 29, 2010

(30) Foreign Application Priority Data
Oct. 5, 2010 (KR) 10-2010-0097025

(51) Int. Cl. G05D 23/00; B01J 19/00

(52) U.S. Cl. 422/109; 422/119

(57) ABSTRACT

Disclosed is a gas hydrate reactor including a supply line for supplying water and gas, a thermoelectric module assembly, a front panel including an observation window, and a housing to which the thermoelectric module assembly and the front panel are attached and into which water and gas are supplied using the supply line so that a gas hydrate is formed therein. This reactor enables rapid and precise temperature control, thus allowing accurate data about properties to be easily acquired in kinetics, phase equilibrium, morphology and microscopic (Raman, XRD, etc.) research of a gas hydrate, thereby leading to the discovery of a gas hydrate production/decomposition mechanism and ensuring important information necessary for a gas hydrate application process.

### BACKGROUND OF THE INVENTION

1. Technical Field

The present invention relates to a reactor for producing a gas hydrate. More particularly, the present invention relates to a gas hydrate reactor, comprising a supply line for supplying water and gas, a thermoelectric module assembly, a front panel including an observation window, and a housing to which the thermoelectric module assembly and the front panel are attached and into which water and gas are supplied using the supply line so that a gas hydrate is formed therein.

2. Description of the Related Art

A clathrate hydrate or gas hydrate is composed of two components, namely, a host molecule which forms hydrogen-bonded solid lattices and a guest molecule that is captured in the host molecule, and refers to a crystalline compound in which monomers such as methane, ethane, carbon dioxide, etc., are not chemically bonded but are physically captured in a three-dimensional lattice structure formed by hydrogen bonding of water molecules.

There are about 130 species of guest molecules known to date which are able to be captured in the gas hydrate. These are exemplified by CH₄, C₂H₆, C₃H₈, CO₂, H₂, SF₆, etc. The gas hydrate crystal structures include polyhedron shaped cavities defined by hydrogen-bonded water molecules, and are classified into, depending on the type of gas molecule and the production conditions, a body-centered cubic structure I (sI), a diamond cubic structure II (sII), and a hexagonal structure H (sH). As such, sI and sII are determined by the size of the guest molecule, and the size and shape of the guest molecule are regarded as important in sH.

The production of a gas hydrate is a procedure for re-distributing at least two kinds of molecules in a specific arrangement in the microscopic perspective and is a phase equilibrium procedure essentially accompanied by heat and material transfer in the macroscopic perspective. Thus, related to the gas hydrate production process, there is an essential need to research measuring X-ray diffraction (hereinafter, referred to as “XRD”) and Raman peaks in a microscopic field, kinetics and phase equilibrium in a macroscopic field, and morphology from a microscopic field to a macroscopic field, in order to bring it closer to being commercialized.

In regard to macroscopic research, in the gas hydrate production process, kinetics began and has been being carried out since 2000 but still remains in the beginning stages. The key of gas hydrate application technology is to develop a reactor and process for producing a gas hydrate at high speed and high efficiency. To this end, it is critical that the kinetics that produces gas hydrates, and a production reaction mechanism using a kinetics model for formation of gas hydrates and analysis of heat/material balance are understood, and the development of a reactor and process for exclusively producing a gas hydrate based thereon is attempted.

As such, thermodynamic equilibrium conditions of a gas hydrate are considered to be the most important and basic part of gas hydrate application research. Such phase equilibrium conditions include temperature and pressure conditions for converting a gas into a solid gas hydrate and also a zone able to maintain a stable state.

Recently in regard to microscopic research, it is possible to determine the crystal structure of a gas hydrate and the common occupancy ratio of a guest molecule using advanced measuring instruments such as an XRD analyzer and a Raman spectroscopy method, and furthermore to analyze the properties of the hydrate in the molecular level in real time. However, because the formation or decomposition of a gas hydrate is accompanied by latent heat and sensible heat, the resulting temperature may fall outside the temperature range required in the experiment, and time delay may occur when controlling such a temperature range, adversely affecting precise analysis. If the temperature is rapidly and accurately controlled in the course of formation and dissociation of the gas hydrate, the structures of molecular arrangement, phase equilibrium and experimental values of basic properties, which were known as results of microscopic research, may be accurately analyzed and thus very important outcomes may be achieved.

Meanwhile, morphology is a field that studies how the nuclei of crystals are produced, moved, grown and interfere with each other, with an interest in the shape and size of a boundary between a gas hydrate which is produced or decomposed and a peripheral phase therearound.

As such, a physical model that determines the transfer properties of a gas hydrate is grounded in the permeability of a porous material using a gas hydrate as a substrate, as well as in the effective heat and a material transfer coefficient as confirmed by morphology research. These features are essential to the design of an industrial process dealing with the production, storage, recovery and separation of a gas hydrate. Hence, morphology research discovers the relationship between macroscopic properties with respect to factors such as local temperature, concentration, gradient thereof and growth rate upon production of a gas hydrate, and therefore it is indispensable regarding techniques used to store, transport, etc. a gas hydrate.

However, conventional gas hydrate reactors used in such microscopic, macroscopic and morphological research have failed to provide rapid and accurate temperature control.

FIG. 1 shows such a conventional gas hydrate reactor.

Water and gas are supplied from a water supply unit 1 and a gas supply unit 2, and the supplied water and gas are mixed in a mixing chamber 3 and then introduced into a reactor 4.

Although slightly varying depending on the conditions for forming a gas hydrate, the reactor 4 should typically be under a high-pressure low-temperature atmosphere. In doing so, the supply of gas is used to adjust the internal pressure of the reactor 4, and the temperature is controlled by adjusting the temperature of a water bath 6.

In particular, in order to maintain a low-temperature atmosphere, the temperature of the water bath 6 should be considerably low.

Also, a stirrer 5 may be used to promote the formation of a gas hydrate, and the formed gas hydrate is stored in a storage unit 7.

According to an embodiment of a conventional reactor, a lens (not shown) of a microscope with a camera equipped with a charge coupled device (CCD) is additionally located in the reactor, and a digital camera operated therewith is used, thereby obtaining and recording an image.

The conventional gas hydrate reactor has the following problems.

In the macroscopic and microscopic research essential for studying the important mechanism and properties of a gas hydrate and in kinetics, phase equilibrium, morphology and microscopic (Raman, XRD, etc.) research of a gas hydrate, a function of rapid and precise temperature control may be provided by the present invention, thus allowing accurate data about properties to be easily acquired, thereby leading to the discovery of a production/decomposition mechanism of a gas hydrate and ensuring important information necessary for a gas hydrate application process. A reactor (which is required for kinetics, phase equilibrium, morphology, Raman, XRD, etc.) should be able to rapidly and precisely control temperature and pressure even upon small scale production, unlike commercial facilities that are for continuous mass production, and should facilitate observation and measurement.

As mentioned above, the gas hydrate reactor suitable to the kinetics, morphology and phase equilibrium of a gas hydrate should be able to precisely control the temperature and pressure even when used in small scale production unlike commercial facilities for continuous mass production, and should facilitate observation and measurement.

The conventional gas hydrate reactor as shown in FIG. 1 is problematic because the reactor 4 is located within the water bath 6, making it very difficult to accurately and rapidly control the internal temperature of the reactor in which a gas hydrate is being produced. Furthermore, because the water bath 6 is filled with water, it is difficult to precisely control the temperature due to the thermodynamic inertia of water. Even when the temperature of water of the water bath 6 is precisely controlled, the internal temperature of the reactor 4 is indirectly affected by the temperature of the water bath 6, making it impossible to perform rapid and accurate temperature control inside the reactor 4.

Moreover, a gas hydrate reaction needs a high-pressure low-temperature environment. To this end, the reactor 4 is set under high-pressure low-temperature conditions. However, in order to measure XRD and Raman peaks to check the formation of a gas hydrate and to determine stability thereof, methods of sampling a gas hydrate that has formed within the high-pressure low-temperature reactor 4 from outside the reactor 4, and analyzing it, are typical. Therefore, it is difficult to perform the accurate measurements attributable to such procedures which discharge a gas hydrate out of the reactor and maintain it.

### SUMMARY OF THE INVENTION

Accordingly, the present invention has been made keeping in mind the problems encountered in the related art and the present invention is intended to provide a gas hydrate reactor, which enables the internal temperature of the gas hydrate reactor to be rapidly and precisely controlled, thereby obtaining accurate data necessary for kinetics and phase equilibrium research.

In particular, the present invention is intended to provide a small, laboratory scale (not for mass production), gas hydrate reactor that is for analyzing properties.

Also the present invention is intended to provide a gas hydrate reactor, which is able to measure the properties of a gas hydrate within the reactor using a variety of measuring instruments, without the gas hydrate being discharged out of the reactor.

Also the present invention is intended to provide a gas hydrate reactor, which is preferable in terms of morphology research.

An aspect of the present invention provides a gas hydrate reactor, comprising a supply line for supplying water and gas, a thermoelectric module assembly, a front panel including an observation window, and a housing to which the thermoelectric module assembly and the front panel are attached and into which water and gas are supplied using the supply line so that a gas hydrate is formed therein.

In this aspect, the housing may be disposed in a buffer chamber, and one side of the thermoelectric module assembly may be heat exchangeable with the reactor and the other side thereof may be heat exchangeable with the buffer chamber.

Also, a measuring instrument may be disposed adjacent to the buffer chamber to measure an inside of the gas hydrate reactor, and a probe of the measuring instrument may be connected to the inside of the reactor, and the measuring instrument may be any one or more selected from among a microscope with a camera equipped with a CCD, an XRD analyzer, and a Raman spectroscopy.

Furthermore, the probe may be compress fitted to the gas hydrate reactor so as to provide pressure sealing.

Also, a pressure gauge and a thermometer may be disposed in the gas hydrate reactor, and the amounts of water and gas supplied using the supply line, the pressure of the reactor measured using the pressure gauge and the temperature of the reactor measured using the thermometer may be applied to a controller unit.

Also, data measured using the measuring instrument may be recorded in the controller unit.

Also, the controller unit may control a power supply unit for supplying power to the thermoelectric module assembly, thus controlling the temperature of the reactor.

Also, the gas hydrate reactor may be used to study kinetics, morphology and phase equilibrium of a gas hydrate.

### BRIEF DESCRIPTION OF THE DRAWINGS

The features and advantages of the present invention will be more clearly understood from the following detailed description taken in conjunction with the accompanying drawings, in which:

FIG. 1 is a schematic view showing a conventional gas hydrate reactor;

FIGS. 2A and 2B are a schematic view and a schematic perspective view showing a gas hydrate reactor according to the present invention, respectively;

FIG. 3 is a perspective view showing the gas hydrate reactor according to the present invention;

FIG. 4 is an exploded perspective view showing the gas hydrate reactor according to the present invention;

FIGS. 5A and 5B are perspective views showing a thermoelectric module assembly according to the present invention; and

FIG. 5C is an exploded perspective view showing the thermoelectric module assembly according to the present invention.

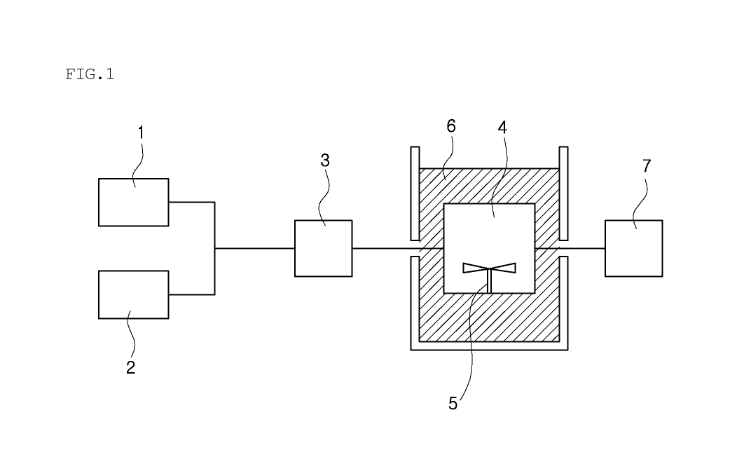

### DESCRIPTION OF SPECIFIC EMBODIMENTS

Hereinafter, embodiments of the present invention will be described in detail while referring to the accompanying drawings.

As used herein, the term “gas” means a guest molecule of a gas hydrate, and the term “water” means a host molecule. In the gas hydrate production, the molecule usable as the guest molecule includes CH₄, O₂H₆, C₃H₈, CO₂, H₂, SF₆ and so on, and such a guest molecule is referred to as a gas. Also, the host molecule is exemplified by water (H₂O).

Although valves are not shown or described below for the sake of simplification of the drawings, they are preferably located at respective pipes and input ports. In particular, a check valve for backflow prevention and a needle valve for precise control may be used.

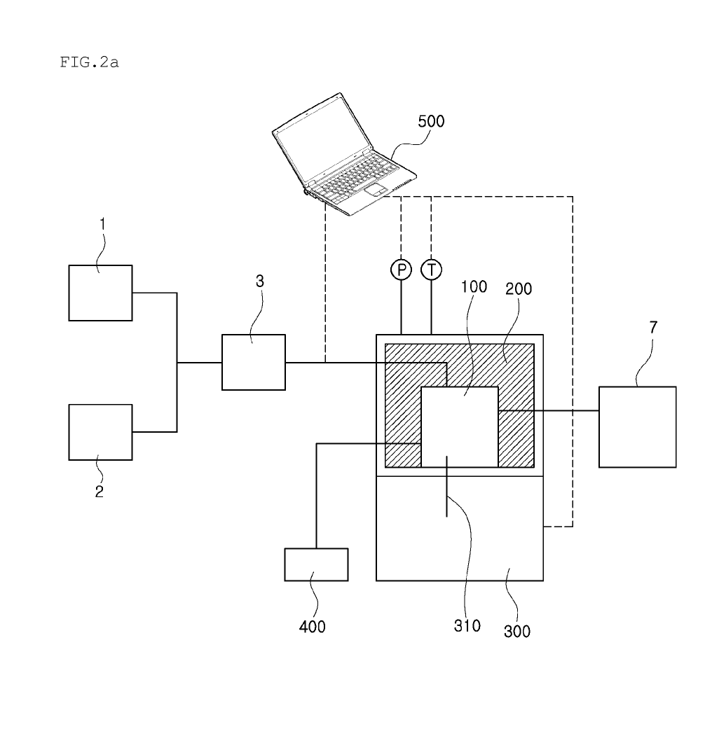

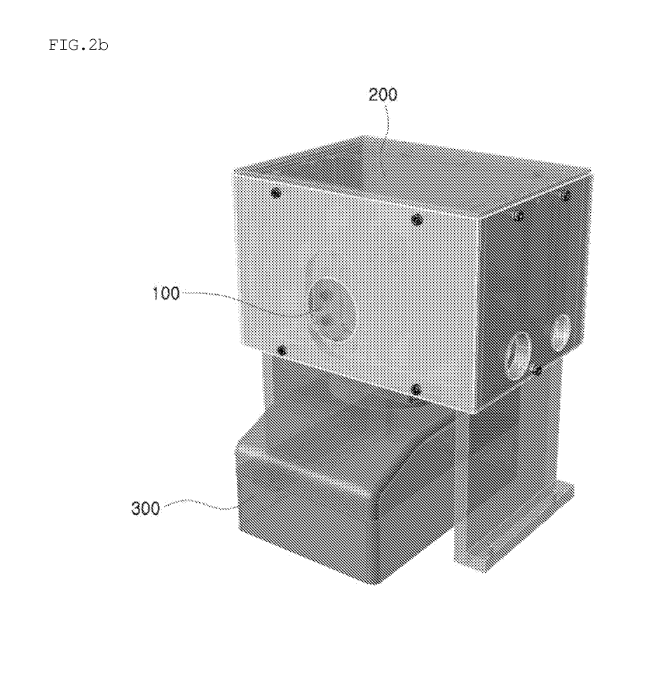

FIGS. 2A and 2B show a gas hydrate reactor 100 according to the present invention.

As in conventional techniques, water and gas are supplied from a water supply unit 1 and a gas supply unit 2, mixed together in a mixing chamber 3 and then supplied into a gas hydrate reactor 100.

The gas hydrate reactor 100 according to the present invention is located not in a water bath but in a buffer chamber 200. Whereas the water bath performs a direct endothermic or exothermic reaction with the reactor to thereby control the temperature of the reactor, the buffer chamber 200 functions to absorb heat emitted from a thermoelectric module assembly 130 attached to one side of the gas hydrate reactor 100. The thermoelectric module assembly 130 is described later.

According to an embodiment of the present invention, a measuring instrument 300 is located around the buffer chamber 200 in which the gas hydrate reactor 100 is disposed. The measuring instrument 300 may be any one or more selected from among a microscope with a camera equipped with a CCD, an XRD analyzer, and a Raman spectroscopy.

A measuring probe 310 of the measuring instrument 300 may be directly connected to the inside of the gas hydrate reactor 100. The inside of the gas hydrate reactor 100 is in a high-pressure low-temperature atmosphere, and thus compress fitting is applied outside the probe 310 so as to effect pressure sealing of the gas hydrate reactor 100, and also a thin O-ring is attached to the inside of the probe 310, thus ensuring inner sealing.

The probe 310 may vary depending on the type of the measuring instrument 300. For example, in the case where the measuring instrument 300 is a microscope, the probe 310 may be a lens, and in the case where the measuring instrument 300 is a Raman peak detector, the probe 310 may be a Raman probe.

As will be specified below, the thermoelectric module assembly 130 is attached to one side of the gas hydrate reactor 100. The thermoelectric module assembly 130 is powered by a power supply unit 400.

Also provided in the gas hydrate reactor 100 are a pressure gauge and a thermometer.

According to an embodiment of the present invention, water and gas supplied into the gas hydrate reactor 100 and power supplied to the thermoelectric module assembly 130 may be recorded via an additional controller unit 500 and may also be controlled by means of an actuator (not shown).

Also, water and gas supplied into the gas hydrate reactor 100 may be measured by a supply line 120 located directly outside the gas hydrate reactor 100, but are preferably determined by measuring the amount used in the water supply unit 1 or the gas supply unit 2.

Furthermore, a variety of data measured using the measuring instrument 300 may be recorded via the controller unit 500.

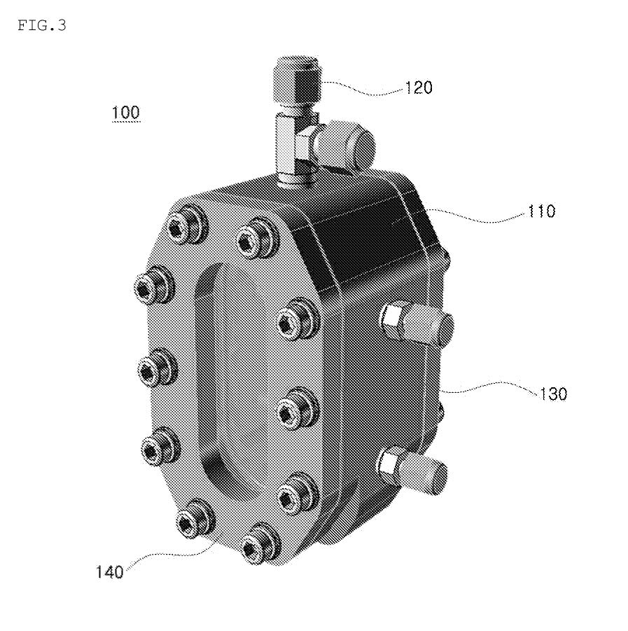

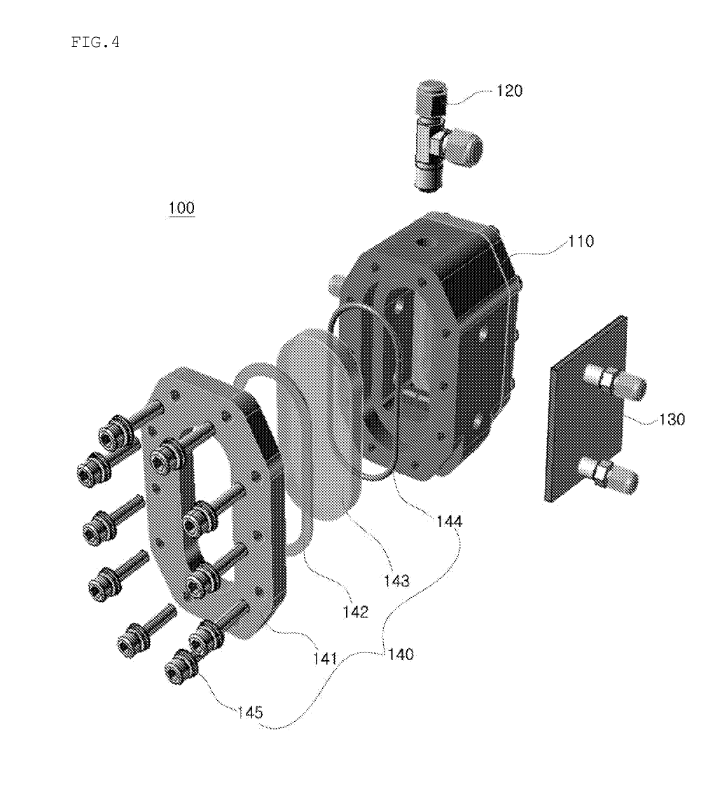

FIGS. 3 and 4 specify the gas hydrate reactor 100 in detail. A thermoelectric module assembly 130 is schematically shown in FIGS. 3 and 4.

The gas hydrate reactor 100 includes a housing 110 which constitutes the main body of the gas hydrate reactor and in which a gas hydrate is produced, a supply line 120 for supplying water and gas to the housing 100, a thermoelectric module assembly 130 for accurately controlling the internal temperature of the housing 100, and a front panel 140 including a window 143 located to facilitate observation.

In particular, the front panel 140 is configured such that a front cover 141, Teflon 142, a window 143 made of reinforced glass, and sealing members 142, 144 such as O-rings are securely connected to the housing 110 by means of connection members 145.

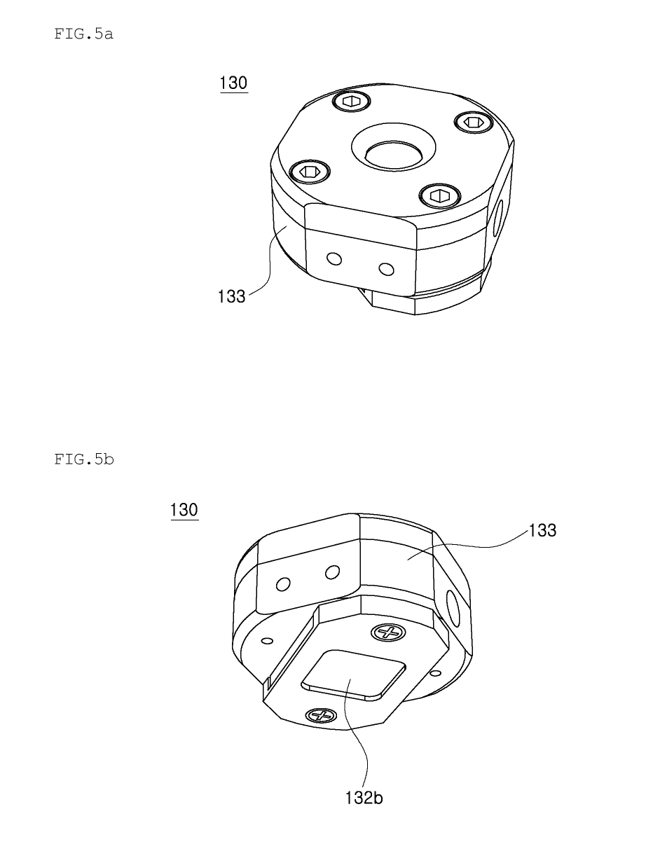

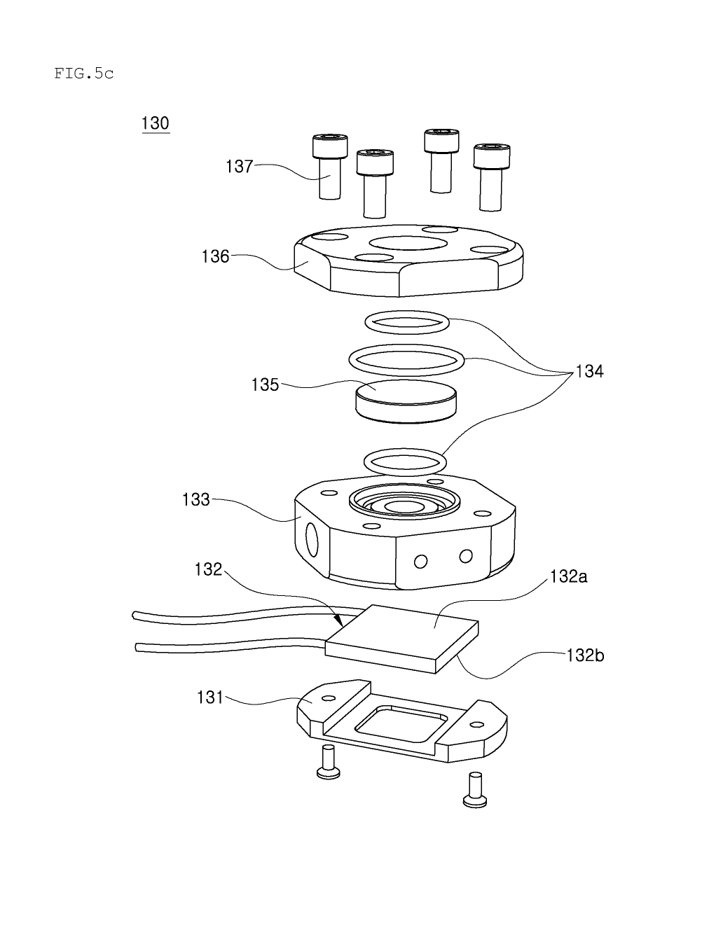

With reference to FIGS. 5A and 5B, the thermoelectric module assembly 130 is specifically described.

The thermoelectric module assembly 130 is configured such that a bracket 131, a thermoelectric module 132 located on the bracket 131, a body 133, a plurality of sealing members 134, a window 135 made of reinforced glass, and a cap 136 are connected with each other by means of connection members 137.

The thermoelectric module 132 is a system for exchanging heat and electric energy and controls electric energy, and thereby rapid and precise cooling and heating are possible. This is unsuitable for mass-production gas hydrate reactors, but is adapted for a gas hydrate reactor 100 for analyzing properties on a small scale as in the present invention, and in particular, is responsible for precisely controlling the internal temperature of the gas hydrate reactor 100. Specifically, as the thermoelectric module is attached to the inside of the reactor, the functions of 1) momentary and precise temperature control, 2) reduction in size, 3) easiness of mounting, and 4) simultaneous heating and cooling may be ensured in terms of analyzing a wide variety of properties of a gas hydrate, thereby finding out a more accurate and definite hydrate production/decomposition mechanism and ensuring important information necessary for a gas hydrate application process.

When one side of the thermoelectric module 132 is endothermic, the other side thereof is exothermic.

Specifically, when the rear side 132b of the thermoelectric module 132 corresponding to the side attached to the gas hydrate reactor 100 is endothermic, the inside of the gas hydrate reactor 100 is rapidly cooled. In this procedure, the front side 132a of the thermoelectric module is exothermic, and the generated heat is absorbed by water in the buffer chamber 200.

Thus, when the user controls the power supply unit 400 via the controller unit 500, the temperature of the thermoelectric module 132 is controlled, so that the temperature of the gas hydrate reactor 100 having the thermoelectric module assembly 130 attached thereto is rapidly and precisely controlled. The heat generated by this procedure may diffuse via the buffer chamber 200, and the buffer chamber 200 may be periodically or non-periodically cooled by a user so as to enable absorption of heat.

As described hereinbefore, the present invention provides a gas hydrate reactor comprising a thermoelectric module. According to the present invention, the gas hydrate reactor which enables rapid and precise temperature control can be provided.

Because rapid and precise temperature control is possible, temperature uncertainty is excluded in kinetics, phase equilibrium, morphology and microscopic research, thus allowing accurate data to be acquired.

Furthermore, a gas hydrate can be directly measured within the reactor instead of being discharged from the reactor and being measured outside the reactor, thus obtaining more accurate data.

Although the embodiments of the present invention have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A gas hydrate reactor, comprising:
a supply line for supplying water and gas;
a thermoelectric module assembly;
a front panel including an observation window; and
a housing to which the thermoelectric module assembly and the front panel are attached and into which water and gas are supplied using the supply line so that a gas hydrate is formed therein.

2. The gas hydrate reactor as set forth in claim 1, wherein the housing is disposed in a buffer chamber, and one side of the thermoelectric module assembly is heat exchangeable with the reactor and the other side thereof is heat exchangeable with the buffer chamber.

3. The gas hydrate reactor as set forth in claim 2, wherein a measuring instrument is disposed adjacent to the buffer chamber to measure an inside of the gas hydrate reactor, and a probe of the measuring instrument is connected to the inside of the reactor, and the measuring instrument is any one or more selected from among a microscope with a camera equipped with a charge coupled device, an X-ray diffraction analyzer, and a Raman spectroscopy.

4. The gas hydrate reactor as set forth in claim 3, wherein the probe is compress fitted to the gas hydrate reactor so as to provide pressure sealing.

5. The gas hydrate reactor as set forth in claim 4, wherein a pressure gauge and a thermometer are disposed in the gas hydrate reactor, and amounts of water and gas supplied using the supply line, a pressure of the reactor measured using the pressure gauge, and a temperature of the reactor measured using the thermometer are applied to a controller unit.

6. The gas hydrate reactor as set forth in claim 5, wherein data measured using the measuring instrument is recorded in the controller unit.

7. The gas hydrate reactor as set forth in claim 6, wherein the controller unit controls a power supply unit for supplying power to the thermoelectric module assembly, thereby controlling the temperature of the reactor.

8. The gas hydrate reactor as set forth in claim 1, wherein the gas hydrate reactor is used to study kinetics, morphology and phase equilibrium of a gas hydrate.
